(19) United States
(12) Patent Application Publication
(10) Pub. No.: US 2020/0301296 A1
(43) Pub. Date: Sep. 24, 2020

(54) EMULSION AGGREGATION PROCESS

(71) Applicant: Xerox Corporation, Norwalk, CT (US)

(72) Inventors: Shivanthi Easwari Sriskandha, Mississauga (CA); Richard P N Veregin, Mississauga (CA); Edward G. Zwartz, Mississauga (CA); Michael S. Hawkins, Cambridge (CA)

(21) Appl. No.: 16/355,938

(22) Filed: Mar. 18, 2019

(51) Int. Cl. G03G 9/08; G03G 9/093

(52) U.S. Cl. CPC G03G 9/0804; G03G 9/0808; G03G 9/09392; G03G 9/0827; G03G 9/09371; G03G 9/0819; G03G 9/09385

(57) ABSTRACT

Described herein is a method for manufacturing a low gloss toner. The method includes mixing a resin, a colorant and an optional wax in water to form an emulsion. The emulsion is heated in the presence of a polyion coagulant to form a plurality of aggregated particles, wherein the heating is to a temperature of below the glass transition temperature of the resin. Trisodium citrate dihydrate is added to the heated emulsion in amount of from 0.4 weight percent to about 1.0 percent by weight based on of a total weight of reagents while stirring, wherein the trisodium citrate dihydrate. The aggregated particles are heated to a temperature above the glass transition temperature of the resin to form toner particles have a volume average particle diameter of from 4.3 microns to 4.9 microns.

### BACKGROUND

### Field of Use

This disclosure is generally directed to toner processes and more specifically aggregation and coalescence processes.

### Background

Emulsion aggregation (EA) toner particles may comprise polyester resins, which are aggregated to form structures of a desired shape and size, followed by the coalescence of the aggregated particles, for example, at an elevated temperature. The components incorporated into the toner shape the characteristics of the final toner particles. For example, a colorant may be added, a wax may be added to provide release from a fuser roll, and a particular binder resin may be added to provide a low minimum fusing temperature (MFT). Another toner property which may be controlled by the components of the EA toner particles is fused image gloss. Examples of teachings of materials and methods for making EA toner are described in U.S. Pat. Nos. 5,290,654; 5,344,738; 5,346,797; 5,496,676; 5,501,935; 5,747,215; 5,840,462; 5,869,215; 6,828,073; 6,890,696; 6,936,396; 7,037,633; 7,049,042; 7,160,661; 7,179,575; 7,186,494; 7,217,484; 7,767,376; 7,829,253; 7,858,285; and 7,862,971, the disclosure of each hereby is incorporated by reference in its entirety.

Controlling gloss in a toner images is accomplished in various ways. Lower gloss provides an offset type look to the toner images, which is desirable in certain applications. Gloss control is typically accomplished by use of HIDS or EDTA chelating agents. However, HIDS requires relatively high amounts added to the manufacturing process with the resultant increase in cost. EDTA, can control gloss, but the process is very sensitive and not readily controllable.

It would be desirable to have toner manufacturing process that can control gloss of the resulting toner that is repeatable and cost effective.

### SUMMARY

Disclosed herein is a method for manufacturing a low gloss toner. The method includes mixing a resin, a colorant, an optional wax, in water to form an emulsion. The method includes heating the emulsion in the presence of an polyion coagulant to form a plurality of aggregated particles of resin, colorant, charge control agent and optional wax, wherein the heating is at a temperature below the glass transition temperature of the resin. Trisodium citrate dehydrate is added in amount of from 0.4 weight percent to about 1.0 percent by weight based on of a total weight of reagents to the heated emulsion while stirring. The method includes heating the aggregated particles to a temperature above the glass transition temperature of the resin to form toner particles have a volume average particle diameter of from 4.3 microns to 4.9 microns. The toner particles are separated and dried. Additionally, there is disclosed a method for manufacturing a low gloss toner. The method includes mixing a resin, a colorant, an optional wax, in water to form an emulsion. The emulsion is heated in the presence of an aluminum coagulant to form a plurality of aggregated particles of resin, colorant, charge control agent and optional wax, wherein the heating is to a temperature of below the glass transition temperature of the resin. The method includes adding trisodium citrate dihydrate to the heated emulsion while stirring, wherein the trisodium citrate dihydrate is added in amount of from 0.4 weight percent to about 1.0 percent by weight based on of a total weight of reagents. The method includes heating the aggregated particles to a temperature above the glass transition temperature of the resin to form toner particles having a volume average particle diameter of from 4.3 microns to 4.9 microns. The toner particles are separated and dried.

Further, there is disclosed herein a low gloss toner that includes particles of a resin, a colorant and a wax. The particles have a size of from 4.3 microns to about 4.9 microns. The particles comprise an aluminum concentration of greater than 150 ppm and a Gardner gloss unit of from 15 to 50.

### DESCRIPTION OF THE EMBODIMENTS

The present disclosure provides a method that is cost effective, repeatable and controls gloss of the toner particles. Using a chelating agent, such as trisodium citrate dihydrate the extraction of aluminum is controlled. The method disclosed herein includes mixing reagents of one or more amorphous resins, an optional crystalline resin, an optional wax, an optional colorant and an optional gel latex to form an emulsion comprising a resin particle. An aluminum coagulant or flocculant is added which aggregates the resin particle to form a nascent toner particle. Optionally, one or more resins are added to form a shell on the nascent toner particles to yield a core-shell particle. Particle growth is controlled and aluminum concentration is controlled by adding a trisodium citrate dihydrate to form an aggregated toner particle. The aggregated toner particles having low gloss are collected.

### Toner Particles

The toner particles include one or more resins, and may include other optional reagents, such as, a surfactant, a wax, a shell and so on. The toner composition optionally may comprise inert particles, which may serve as toner particle carriers, which may comprise the resin taught herein. The inert particles may be modified, for example, to serve a particular function. Hence, the surface thereof may be derivatized or the particles may be manufactured for a desired purpose, for example, to carry a charge or to possess a magnetic field.

### Components

1. Resin

Toner particles of the instant disclosure may comprise any known resin as known in the art as suitable therefor. The discussion below focuses on polyester polymers.

In embodiments, bifunctional reagents, trifunctional reagents and so on may be used. One or more reagents that comprise at least three functional groups that can be incorporated into a polymer to enable branching and/or crosslinking. Examples of such polyfunctional monomers for a polyester include 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane and 1,2,7,8-octanetetracarboxylic acid, acid anhydrides thereof, lower alkyl esters thereof and so on. The branching agent may be used in an amount from about 0.01 to about 10 mole %, from about 0.05 to about 8 mole %, from about 0.1 to about 5 mole %. Polyester resins, for example, may be used for applications requiring low melting temperature.

One, two or more polymers may be used in forming a toner or toner particle. In embodiments where two or more polymers are used, the polymers may be in any suitable ratio (e.g., weight ratio) such as, for instance, with two different polymers, from about 1% (first polymer)/99% (second polymer) to about 99% (first polymer)/1% (second polymer), from about 10% (first polymer)/90% (second polymer) to about 90% (first polymer)/10% (second polymer) and so on, as a design choice.

The polymer may be present in an amount of from about 65 to about 95% by weight, from about 75 to about 85% by weight of toner particles on a solids basis.

a. Polyester Resins

Suitable polyester resins include, for example, those which are sulfonated, non-sulfonated, crystalline, amorphous, combinations thereof and the like. The polyester resins may be linear, branched, crosslinked, combinations thereof and the like.

When a mixture is used, such as amorphous and crystalline polyester resins, the ratio of crystalline polyester resin to amorphous polyester resin may be in the range from about 1:99 to about 30:70; from about 5:95 to about 25:75; from about 5:95 to about 15:95.

A polyester resin may be obtained synthetically, for example, in an esterification reaction involving a reagent comprising polyacid groups and another reagent comprising a polyol. In embodiments, the alcohol reagent comprises three or more hydroxyl groups, in embodiments, four or more hydroxyl groups, or more. In embodiments, the polyacid comprises three or more carboxylic acid groups, in embodiments, four or more carboxylic acid groups, or more. Reagents comprising three or more functional groups enable, promote or enable and promote polymer branching and crosslinking. In embodiments, a polymer backbone or a polymer branch comprises at least one monomer unit comprising at least one pendant group or side group, that is, the monomer reactant from which the unit was obtained comprises at least three functional groups.

Examples of polyols which may be used in generating an amorphous polyester resin include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, 1,4-cyclohexanedimethanol, 1,3-cyclohexanedimethanol xylenedimethanol, cyclohexanediol, diethylene glycol, bis(2-hydroxyethyl) oxide, dipropylene glycol, dibutylene glycol, and combinations thereof. The amount of polyol may vary, and may be present, for example, in an amount from about 40 to about 60 mole % of the resin, from about 42 to about 55 mole % of the resin, from about 45 to about 53 mole % of the resin.

Examples of polyacids or polyesters that can be used include terephthalic acid, phthalic acid, isophthalic acid, fumaric acid, trimellitic acid, diethyl fumarate, dimethyl itaconate, cis-1,4-diacetoxy-2-butene, dimethyl fumarate, diethyl maleate, maleic acid, succinic acid, itaconic acid, succinic acid, cyclohexanoic acid, succinic anhydride, dodecylsuccinic acid, dodecylsuccinic anhydride, glutaric acid, glutaric anhydride, adipic acid, pimelic acid, suberic acid, azelaic acid, dodecanedioic acid, dimethyl naphthalenedicarboxylate, dimethyl terephthalate, diethyl terephthalate, dimethylisophthalate, diethylisophthalate, dimethylphthalate, phthalic anhydride, diethylphthalate, dimethylsuccinate, naphthalene dicarboxylic acid, dimer diacid, dimethylfumarate, dimethylmaleate, dimethylglutarate, dimethyladipate, dimethyl dodecylsuccinate and combinations thereof.

Examples of amorphous resins which may be used include alkali sulfonated-polyester resins, branched alkali sulfonated-polyester resins, alkali sulfonated-polyimide resins and branched alkali sulfonated-polyimide resins. Alkali sulfonated polyester resins may be useful in embodiments, such as, the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate) and copoly(propylene-butylene-terephthalate)-copoly(propylene-butylene-5-sulf-o-isophthalate), wherein the alkali metal is, for example, a sodium, a lithium or a potassium ion.

In embodiments, an unsaturated amorphous polyester resin may be used as a latex resin. Exemplary unsaturated amorphous polyester resins include, but are not limited to, poly(1,2-propylene fumarate), poly(1,2-propylene itaconate) and combinations thereof.

For forming a crystalline polyester resin, suitable polyols include aliphatic polyols with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-,1,3-propanediol, lithio 2-sulfo-1,3-propanediol, potassio 2-sulfo-1,3-propanediol, mixtures thereof and the like, including structural isomers thereof.

Examples of polyacid or polyester reagents for preparing a crystalline resin include oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, mesaconic acid, a polyester or anhydride thereof, an alkali sulfo-organic polyacid, such as, the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfo-p-hydroxybenzoic acid. N,N-bis(2-hydroxyethyl)-2-amino ethane sulfonate, or mixtures thereof. The polyacid may be selected in an amount of, for example, in embodiments, from about 40 to about 60 mole %, from about 42 to about 52 mole %, from about 45 to about 50 mole %. Optionally, a second polyacid may be selected in an amount from about 0.1 to about 10 mole % of the resin.

Specific crystalline resins include poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipatenonylene-decanoate), poly(octylene-adipate), and so on, wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide) and poly(butylene-succinimide).

Suitable crystalline resins which may be utilized, optionally in combination with an amorphous resin as described above. A suitable crystalline resin may include a resin formed of ethylene glycol and a mixture of dodecanedioic acid and fumaric acid comonomers.

Examples of other suitable resins or polymers which may be utilized in forming a toner include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and combinations thereof. The polymer may be, for example, block, random or alternating copolymers.

The crystalline resin may be present, for example, in an amount from about 1 to about 85% by weight of the toner components, in embodiments, from about 2 to about 50% by weight of the toner components, from about 5 to about 15% by weight of the toner components. The crystalline resin may possess various melting points of, for example, from about 30° C. to about 120° C. from about 50° C. to about 90° C., from about 60° C. to about 80° C. The crystalline resin may have a number average molecular weight (Mₙ), as measured by gel permeation chromatography (GPC) of, for example, from about 1,000 to about 50,000, from about 2,000 to about 25,000; and a weight average molecular weight (M_{w}) of from about 2,000 to about 100,000, from about 3,000 to about 80,000, as determined by GPC. The molecular weight distribution (M_{w}/Mₙ) of the crystalline resin may be, for example, from about 2 to about 6, from about 3 to about 4.

b. Catalyst

Condensation catalysts may be used to facilitate the condensation reaction and when present, can include tetraalkyl titanates; dialkyltin oxides, such as, dibutyltin oxide; tetraalkyltins, such as, dibutyltin dilaurate; dibutyltin diacetate; dialkyltin oxide hydroxides, such as, butyltin oxide hydroxide; aluminum alkoxides, alkyl zinc, dialkyl zinc, zinc oxide, stannous oxide, stannous chloride or combinations thereof. In embodiments, such catalysts may include butylstannoic acid (Fascat 4100®) and dibutyltin oxide (Fascat 4201®), Arkema Inc., Philadelphia, Pa.

Such catalysts may be used in amounts of, for example, from about 0.01 mole % to about 5 mole % based on the amount of starting polyacid, polyol or polyester reagent in the reaction mixture.

c. Initiator

In embodiments, the resin may be a crosslinkable resin. A crosslinkable resin is a resin, for example, including a crosslinkable group or groups such as a C═C bond or a pendant group or side group, such as, a carboxylic acid group. The resin may be crosslinked, for example, through a free radical polymerization with an initiator.

Suitable initiators include peroxides, such as, organic peroxides or azo compounds, for example diacyl peroxides, such as, decanoyl peroxide, lauroyl peroxide and benzoyl peroxide, ketone peroxides, such as, cyclohexanone peroxide and methyl ethyl ketone; alkyl peroxy esters, such as, t-butyl peroxy neodecanoate, 2,5-dimethyl 2,5-di(2-ethyl hexanoyl peroxy)hexane, t-amyl peroxy 2-ethyl hexanoate, t-butyl peroxy 2-ethyl hexanoate, t-butyl peroxy acetate, t-amyl peroxy acetate, t-butyl peroxy benzoate and t-amyl peroxy benzoate; alkyl peroxides, such as, dicumyl peroxide, 2,5-dimethyl 2,5-di(t-butyl peroxy)hexane, t-butyl cumyl peroxide, bis(t-butyl peroxy)diisopropyl benzene, di-t-butyl peroxide and 2,5-dimethyl 2,5-di(t-butyl peroxy)hexyne-3; alkyl hydroperoxides, such as, 2,5-dihydro peroxy 2,5-dimethyl hexane, cumene hydroperoxide, t-butyl hydroperoxide and t-amyl hydroperoxide, and alkyl peroxyketals, such as, n-butyl 4,4-di(t-butyl peroxy)valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2-di(t-butyl peroxy)butane, ethyl 3,3-di(t-butyl peroxy)butyrate and ethyl 3,3-di(t-amyl peroxy)butyrate; azobis-isobutyronitrile, 2,2′-azobis(isobutyronitrile), 2,2′-azobis(2,4-dimethyl valeronitrile), 2,2′-azobis(methyl butyronitrile), 1,1′-azobis(cyano cyclohexane), 1,1-di(t-butyl peroxy)-3,3,5-trimethylcyclohexane, combinations thereof and the like. The amount of initiator used is proportional to the degree of crosslinking, and thus, the gel content of the polyester material. The amount of initiator used may range from, for example, about 0.01 to about 10 weight %, from about 0.1 to about 5 weight % of the polyester resin. In the crosslinking, it is desirable that substantially all of the initiator be consumed. The crosslinking may be carried out at high temperature and thus, the reaction may be very fast, for example, less than 10 minutes, such as, from about 20 seconds to about 2 minutes residence time.

Generally, as known in the art, the polyacid/polyester and polyol are mixed together, optionally with a catalyst, and incubated optionally at an elevated temperature, such as, from about 180° C. or more, from about 190° C. or more, from about 200° C. or more, and so on, which may be conducted anaerobically, to enable esterification to occur until equilibrium, which generally yields water or an alcohol, such as, methanol, arising from forming the ester bonds in esterification reactions. The reaction may be conducted under vacuum to promote polymerization. The product is collected by practicing known methods, and may be dried, again, by practicing known methods to yield particulates.

Polyester resins suitable for use in an imaging device are those which carry one or more properties, such as, a T_{g} (onset) of from about 90° C. to about 150° C., from about 100° C. to about 140° C., from about 110° C. to about 130° C.; a T_{g} of from about 10° C. to about 120° C., from about 20° C. to about 110° C., from about 30° C. to about 100° C.; an acid value (AV) of from about 2 to about 30, from about 3 to about 25, from about 4 to about 20; an Mₙ of from about 2000 to about 100,000, from about 3000 to about 90,000, from about 4000 to about 80,000; a PDI from about 2 to about 8, from about 3 to about 7, from about 4 to about 6; and an M_{w} of at least about 5000, at least about 15,000, at least about 20,000, at least about 100,000.

2. Colorants

Suitable colorants include those comprising carbon black, such as, REGAL 330® and Nipex 35; magnetites, such as, Mobay magnetites, MO8029™ and MO8060™; Columbian magnetites, MAPICO® BLACK; surface-treated magnetites; Pfizer magnetites, CB4799™, CB5300™, CB5600™ and MCX6369™; Bayer magnetites, BAYFERROX 8600™ and 8610™; Northern Pigments magnetites, NP-604™ and NP-608™; Magnox magnetites, TMB-100™ or TMB-104™; and the like.

Colored pigments, such as, cyan, magenta, yellow, red, orange, green, brown, blue or mixtures thereof may be used. The additional pigment or pigments may be used as water-based pigment dispersions.

Examples of pigments include SUNSPERSE 6000, FLEXIVERSE and AQUATONE, water-based pigment dispersions from SUN Chemicals; HELIOGEN BLUE L6900™, D6840™, D7080™, D7020™, PYLAM OIL BLUE™, PYLAM OIL YELLOW™ and PIGMENT BLUE I™ available from Paul Uhlich & Company, Inc.; PIGMENT VIOLET I™, PIGMENT RED 48™, LEMON CHROME YELLOW DCC 1026™, TOLUIDINE RED™ and BON RED C™ available from Dominion Color Corporation, Ltd., Toronto, Ontario; NOVAPERM YELLOW FGL™ and HOSTAPERM PINK E™ from Hoechst; CINQUASIA MAGENTA™ available from E.I. DuPont de Nemours & Co. and the like.

Examples of magenta pigments include 2,9-dimethyl-substituted quinacridone, an anthraquinone dye identified in the Color Index (CI) as CI 60710. CI Dispersed Red 15, a diazo dye identified in the Color Index as CI 26050, CI Solvent Red 19 and the like.

Illustrative examples of cyan pigments include copper tetra(octadecylsulfonamido) phthalocyanine, a copper phthalocyanine pigment listed in the Color Index as CI 74160, CI Pigment Blue, Pigment Blue 15:3, Pigment Blue 15:4, an Anthrazine Blue identified in the Color Index as CI 69810, Special Blue X-2137 and the like.

Illustrative examples of yellow pigments are diarylide yellow 3,3-dichlorobenzidene acetoacetanilide, a monoazo pigment identified in the Color Index as CI 12700, CI Solvent Yellow 16, a nitrophenyl amine sulfonamide identified in the Color Index as Foron Yellow SE/GLN, CI Disperse Yellow 3,2,5-dimethoxy-4-sulfonanilide phenylazo-4′-chloro-2,5-dimethoxy acetoacetanilide and Permanent Yellow FGL.

Other known colorants may be used, such as, Levanyl Black A-SF (Miles, Bayer) and Sunsperse Carbon Black LHD 9303 (Sun Chemicals), and colored dyes, such as, Neopen Blue (BASF), Sudan Blue OS (BASF), PV Fast Blue B2G 01 (American Hoechst), Sunsperse Blue BHD 6000 (Sun Chemicals), Irgalite Blue BCA (CibaGeigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF). Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), SUCD-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich). Scarlet for Thermoplast NSD PS PA (Ugine Kuhlmann of Canada), E. D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing and the like. Other pigments that may be used, and which are commercially available include various pigments in the color classes, Pigment Yellow 74, Pigment Yellow 14, Pigment Yellow 83, Pigment Orange 34, Pigment Red 238, Pigment Red 122, Pigment Red 48:1, Pigment Red 269, Pigment Red 53:1, Pigment Red 57:1, Pigment Red 83:1, Pigment Violet 23, Pigment Green 7 and so on, and combinations thereof.

The colorant, for example, carbon black, cyan, magenta and/or yellow colorant, may be incorporated in an amount sufficient to impart the desired color to the toner. Pigment or dye, may be employed in an amount ranging up to about 35% by weight of the toner particles on a solids basis, up to about 25%, up to about 15% by weight. A toner of interest can comprise higher levels of colorant than found in conventional loner now in commercial use.

3. Optional Components

a. Surfactants

In embodiments, toner compositions may be in dispersions including surfactants. Emulsion aggregation methods where the polymer and other components of the toner are in combination may employ one or more surfactants to form an emulsion.

One, two or more surfactants may be used. The surfactants may be selected from ionic surfactants and nonionic surfactants, or combinations thereof. Anionic surfactants and cationic surfactants are encompassed by the term, “ionic surfactants.”

The surfactant(s) may be used in an amount of from about 0.01% to about 5% by weight of the toner-forming composition, from about 0.75% to about 4% by weight of the toner-forming composition, from about 1% to about 3% by weight of the toner-forming composition.

Examples of nonionic surfactants include, for example, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether and dialkylphenoxy poly(ethyleneoxy) ethanol, for example, available from Rhone-Poulenc as IGEPAL CA210™, IGEPAL CA-520™, IGEPAL CA720™, IGEPAL CO-890™, IGEPAL CO720™, IGEPAL CO290™, IGEPAL CA210™, ANTAROX 890™ and ANTAROX 897™. Other examples of suitable nonionic surfactants include a block copolymer of polyethylene oxide and polypropylene oxide, including those commercially available as SYNPERONIC® PR/F, in embodiments, SYNPERONIC® PR/F 108; and a DOWFAX, available from The Dow Chemical Corp.

Anionic surfactants include sulfates and sulfonates, such as, sodium dodecylsulfate (SDS), sodium dodecylbenzene sulfonate, sodium dodecylnaphthalene sulfate and so on; dialkyl benzenealkyl sulfates; acids, such as, palmitic acid, and NEOGEN or NEOGEN SC obtained from Daiichi Kogyo Seiyaku, and so on, combinations thereof and the like. Other suitable anionic surfactants include, in embodiments, alkyldiphenyloxide disulfonates or TAYCA POWER BN2060 from Tayca Corporation (Japan), which is a branched sodium dodecyl benzene sulfonate. Combinations of those surfactants and any of the foregoing nonionic surfactants may be used in embodiments.

Examples of cationic surfactants include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, trimethyl ammonium bromides, halide salts of quarternized polyoxyethylalkylamines, dodecylbenzyl triethyl ammonium chlorides, MIRAPOL® and ALKAQUAT® available from Alkaril Chemical Company, SANISOL® (benzalkonium chloride) available from Kao Chemicals and the like, and mixtures thereof, including, for example, a nonionic surfactant as known in the art or provided hereinabove.

b. Waxes

The toners of the instant disclosure, optionally, may contain a wax, which may be either a single type of wax or a mixture of two or more different types of waxes (hereinafter identified as, “a wax”.) A wax may be added to a toner formulation or to a developer formulation, for example, to improve particular toner properties, such as, toner particle shape, charging, fusing characteristics, gloss, stripping, offset properties and the like. Alternatively, a combination of waxes may be added to provide multiple properties to a toner or a developer composition. A wax may be included as, for example, a fuser roll release agent.

The wax may be combined with the resin-forming composition for forming toner particles. When included, the wax may be present in an amount of, for example, from about 1 wt % to about 25 wt % of the toner particles, from about 5 wt % to about 20 wt % of the toner particles.

Waxes that may be selected include waxes having, for example, an Mw of from about 500 to about 20,000, from about 1,000 to about 10,000. Waxes that may be used include, for example, polyolefins, such as, polyethylene, polypropylene and polybutene waxes, such as, those that are commercially available, for example, POLYWAX™ polyethylene waxes from Baker Petrolite, wax emulsions available from Michaelman, Inc. or Daniels Products Co., EPOLENE N15™ which is commercially available from Eastman Chemical Products, Inc., VISCOL 550-P™, a low weight average molecular weight polypropylene available from Sanyo Kasei K. K.; plant-based waxes, such as carnauba wax, rice wax, candelilla wax, sumac wax and jojoba oil; animal-based waxes, such as beeswax; mineral-based waxes and petroleum-based waxes, such as montan wax, ozokerite, ceresin wax, paraffin wax, microcrystalline wax and Fischer-Tropsch waxes; ester waxes obtained from higher fatty acids and higher alcohols, such as stearyl stearate and behenyl behenate; ester waxes obtained from higher fatty acids and monovalent or multivalent lower alcohols, such as butyl stearate, propyl oleate, glyceride monostearate, glyceride distearate and pentaerythritol tetrabehenate; ester waxes obtained from higher fatty acids and multivalent alcohol multimers, such as diethyleneglycol monostearate, dipropyleneglycol distearate, diglyceryl dislearate and triglyceryl tetrastearate; sorbitan higher fatty acid ester waxes, such as sorbitan monostearate; cholesterol higher fatty acid ester waxes, such as, cholesteryl stearate, and so on.

Examples of functionalized waxes that may be used include, for example, amines and amides, for example, AQUA SUPERSLIP6550™ and SUPERSLIP6530™ available from Micro Powder Inc.; fluorinated waxes, for example, POLYFLUO 190™, POLYFLUO 200™, POLYSILK 19™ and POLYSILK 14™ available from Micro Powder Inc.; mixed fluorinated amide waxes, for example, MICROSPERSION 19™ also available from Micro Powder Inc.; imides, esters, quaternary amines, carboxylic acids, acrylic polymer emulsions, for example, JONCRYL 74™, 89™, 130™, 537™, and 538™ available from SC Johnson Wax; and chlorinated polypropylenes and polyethylenes available from Allied Chemical, Petrolite Corp. and SC Johnson. Mixtures and combinations of the foregoing waxes also may be used in embodiments.

In embodiments, a toner is a low melt toner. When a wax is included in a low wax toner, the wax(s) may have a Tₘ of about 100° C. or less, about 97.5° C. or less, about 95° C. or less or lower.

c. Surface Additive

In embodiments, the toner particles may be mixed with one or more additives, such as, silicon dioxide or silica (SiO₂), titania or titanium dioxide (TiO₂) and/or cerium oxide. Silica may be a first silica and a second silica. The first silica may have an average primary particle size, measured in diameter, in the range of, for example, from about 5 nm to about 50 nm, from about 5 nm to about 25 nm, from about 20 nm to about 40 nm. The second silica may have an average primary particle size, measured in diameter, in the range of, for example, from about 100 nm to about 200 nm, from about 100 nm to about 150 nm, from about 125 nm to about 145 nm. The second silica may have a larger average size (diameter) than the first silica. The titania may have an average primary particle size in the range of from about 5 nm to about 50 nm, from about 5 nm to about 20 nm, from about 10 nm to about 50 nm. The cerium oxide may have an average primary particle size in the range of from about 5 nm to about 50 nm, from about 5 nm to about 20 nm, from about 10 nm to about 50 nm.

Zinc stearate may be used as an external additive. Calcium stearate and magnesium stearate may provide similar functions. Zinc stearate may have an average primary particle size of, for example, from about 500 nm to about 700 nm, from about 500 nm to about 600 nm, from about 550 nm to about 650 nm.

### Toner Particle Preparation

1. Method

a. Particle Formation

An emulsification/aggregation process, a resin may be dissolved in a solvent, and may be mixed into an emulsion medium, for example, water, such as, deionized water (DIW).

Optionally, a surfactant may be added to the aqueous emulsion medium, for example, to afford additional stabilization to the resin or to enhance emulsification of the resin. Suitable surfactants include anionic, cationic and nonionic surfactants as taught herein.

In embodiments, following emulsification, toner compositions may be prepared by aggregating a mixture of a resin, an optional pigment, an optional wax and any other desired additives in an emulsion, optionally, with surfactants as described above, and then optionally coalescing the aggregate mixture. The pH of the resulting mixture may be adjusted with an acid, such as, for example, acetic acid, nitric acid or the like. In embodiments, the pH of the mixture may be adjusted to from about 2 to about 4.8.

The solids content on the emulsion can be at least about 10%, at least about 15%, at least about 20%, or more. For example, the solids loading can be from about 10% to about 15%, from about 15% to about 20%.

Additionally, in embodiments, the mixture may be homogenized. If the mixture is homogenized, mixing may be at from about 600 to about 4,000 rpm. Homogenization may be by any suitable means, including, for example, an IKA ULTRA TURRAX T50 probe homogenizer.

b. Aggregation

Following preparation of the above mixture, often, it is desirable to form larger particles or aggregates, often sized in micrometers, of the smaller particles from the initial polymerization reaction, often sized in nanometers. An aggregating factor (also known as a coagulant or flocculant) may be added to the mixture. Suitable aggregating factors include, for example, aqueous solutions of a divalent cation, a multivalent cation or a compound comprising same.

A variety of coagulants are known in the art. As used herein, “polyion coagulant” refers to a coagulant that is a salt or oxide, such as a metal salt or metal oxide, formed from a metal species having a valence of at least 3, and desirably at least 4 or 5. The aggregating factor, as provided above contains aluminum and may be, for example, a polyaluminum halide, such as, polyaluminum chloride (PAC) or the corresponding bromide, fluoride or iodide; a polyaluminum silicate, such as, polyaluminum sulfosilicate (PASS); polyaluminum hydroxide, polyaluminum phosphate, and the like or a water soluble aluminum salt, such as, aluminum chloride, aluminum nitrite, aluminum sulfate, potassium aluminum sulfate or combinations thereof. Other suitable coagulants include, but are not limited to, tetraalkyl titinates, dialkyltin oxide, tetraalkyltin oxide hydroxide, dialkyltin oxide hydroxide, aluminum alkoxides, alkylzinc, dialkyl zinc, zinc oxides, stannous oxide, dibutyltin oxide, dibutyltin oxide hydroxide, tetraalkyl tin, poly-silicic-ferric and the like. Where the coagulant is a polyion coagulant, the coagulants may have any desired number of polyion atoms present. For example, suitable polyaluminum compounds, in embodiments, may have from about 2 to about 13, or from about 3 to about 8, aluminum ions present in the compound.

In embodiments, the aggregating factor may be added to the mixture at a temperature that is below the glass transition temperature (T_{g}) of the resin or of a polymer.

The aggregating factor may be added to the mixture components to form a toner in an amount of, for example, from about 0.1 part per hundred (pph) to about 3 pph, from about 0.20 pph to about 2.5 pph or from about 0.25 pph to about 1.0 pph.

To control aggregation of the particles, the aggregating factor may be metered into the mixture over time. For example, the factor may be added incrementally into the mixture over a period of from about 5 to about 240 minutes, from about 30 to about 200 minutes.

Addition of the aggregating factor also may be done while the mixture is maintained under stirred conditions, from about 50 rpm to about 600 rpm, from about 100 rpm to about 400 rpm; and at a temperature at least about 50° C., at least about 51° C., at least about 52° C., at least about 53° C. and higher, up to about 60° C.

The particles are permitted to aggregate until a predetermined size is obtained. Particle size may be monitored during the growth process. For example, samples may be taken during the growth process and analyzed, for example, with a COULTER COUNTER, for average particle size. The aggregation thus may proceed by maintaining the mixture, for example, at least about 50° C., at least about 51° C., or higher, up to about 60° C., and holding the mixture at that temperature for from about 0.5 hours to about 6 hours, from about hour 1 to about 5 hours, while maintaining stirring, to provide the desired aggregated particles. Once the predetermined desired particle size is attained, the growth process is halted by using a chelating agent or controlling the pH.

A sequestering agent or chelating agent is introduced when aggregation is complete and to sequester or to extract in a controlled manner the aluminum, from the aggregation process. Thus, the sequestering, chelating or complexing agent used after aggregation is trisodium citrate dihydrate. The amount of trisodium citrate dihydrate added is from about 0.4 weight percent to about 1.0 percent by weight based on of a total weight of reagents. In embodiments the amount of trisodium citrate dihydrate is from 0.45 percent by weight to about 0.95 percent by weight, or from 0.5 percent by weight to about 0.9 percent by weight of the reagents.

In embodiments, in addition to the trisodium citrate dihydrate, a second sequestering or chelating agent may be added when the aggregation is complete. The second sequestering agent may includes ethylenediaminetetraacetic acid (EDTA), gluconal, hydroxyl-2.2″iminodisuccinic acid (HIDS), dicarboxylmethyl glutamic acid (GLDA), methyl glycidyl diacetic acid (MGDA), hydroxydiethyliminodiacetic acid (HIDA), potassium citrate, sodium citrate, nitrotriacetate salt, humic acid, glutamic acid, gluconic acid, N.N diacetic acid, fulvic acid, hydroxyethylethylene diaminetriacetic acid (HEDTA). (hydroxyethylidene diphosphonioacid (HEDP), humic acid, pentaacetic acid, tetraacetic acid, methylglycine diacetic acid, ethylenediamine disuccinic acid, salts of oxycarboxylic acids, such as, tartaric acid, imino diacid (IDA), nitrilotriacetic acid (NTA), salts of aminopoly carboxylic acids; salts of EDTA, such as, alkali metal salts of EDTA, tartaric acid, oxalic acid, polyacrylates, Sugar acrylates, citric acid, polyaspartic acid, diethylenetriamine pentaacetate, 3-hydroxy-4-pyridinone, dopamine, eucalyptus, iminodisuccinic acid, ethylenediaminedisuccinate, polysaccharide, sodium ethylenedinitrilotetraacetate, thiamine pyrophosphate, farnesyl pyrophosphate, 2-aminoethylpyrophosphate, hydroxyl ethylidene-1,1-diphosphonic acid, aminotrimethylenephosphonic acid, diethylene triaminepentamethylene phosphonic acid, ethylenediamine tetramethylene phosphonic acid, salts of such compounds, and mixtures thereof. The amount of the second sequestering agent may be added in an amount of from 0.45 percent by weight to about 0.95 percent by weight, or from 0.5 percent by weight to about 0.9 percent by weight of the reagents.

Once the desired final size of the nascent toner particles or aggregates is achieved, the pH of the mixture is adjusted with chelating agent alone to a value of from about 6 to about 10, from about 7 to about 9. The adjustment of pH is used, in part, to freeze, that is, to stop, toner particle growth.

The aggregated particles may be less than about 7 microns in size, from about 2 microns to about 7 microns or from about 3 microns to about 6 microns.

c. Shells

In embodiments, after aggregation, generally prior to coalescence, a resin coating may be applied to the aggregated particles to form a shell thereover. Any resin described herein or as known in the art may be used as the shell. In embodiments, a polyester amorphous resin latex as described herein may be included in the shell. In embodiments, a polyester amorphous resin latex described herein may be combined with a different resin, and then added to the particles as a resin coating to form a shell. In embodiments, a low molecular weight amorphous polyester resin may be used to form a shell over the particles or aggregates.

A shell resin may be applied to the aggregated particles by any method within the purview of those skilled in the art. In embodiments, the resins used to form the shell may be in an emulsion, optionally including any surfactant described herein. The emulsion possessing the resins may be combined with the aggregated particles so that the shell forms over the aggregated particles.

Formation of the shell over the aggregated particles may occur while heating to a temperature from 50° C. or greater, from 51° C. or greater, from about 52° C. or greater, from about 53° C. or greater, or more, up to about 60° C. Formation of the shell may take place for a period of time from about 5 minutes to about 10 hours, from about 10 minutes to about 5 hours.

The shell may be present in an amount from about 1% by weight to about 80% by weight of the toner components, from about 10% by weight to about 40% by weight of the toner components, from about 20% by weight to about 35% by weight of the toner components.

d. Coalescence

Following aggregation to a desired particle size and application of any optional shell, the particles then may be coalesced to a desired final shape, such as, a circular shape, for example, to correct for irregularities in shape and size, the coalescence being achieved by, for example, heating the mixture from the aggregation temperature from about 75° C. or greater, from about 80° C. or greater, from about 85° C. or greater, from about 90° C. or greater, or more which may be at or above the T_{g} of the resins or below the melting point of the resin(s) used to form the toner particles, and/or reducing the stirring, for example, to from about 1000 rpm to about 100 rpm, from about 800 rpm to about 200 rpm. Coalescence may be conducted over a period from about 0.01 to about 9 hours, from about 0.1 to about 4 hours.

Optionally, a coalescing agent may be used. Examples of suitable coalescence agents include, but are not limited to, benzoic acid alkyl esters, ester alcohols, glycol/ether-type solvents, long chain aliphatic alcohols, aromatic alcohols, mixtures thereof and the like.

In embodiments, the coalescence agent (or coalescing agent or coalescence aid agent) evaporates during later stages of the emulsion/aggregation process, such as, during a second heating step, that is, generally above the T_{g} of the resin or a polymer. The final toner particles are thus, free of, or essentially or substantially free of any remaining coalescence agent. To the extent that any remaining coalescence agent may be present in a final toner particle, the amount of remaining coalescence agent is such that presence thereof does not affect any properties or the performance of the toner or developer.

The coalescence agent may be added prior to the coalescence or fusing step in any desired or suitable amount. For example, the coalescence agent may be added in an amount of from about 0.01 to about 10% by weight, based on the solids content in the reaction medium, from about 0.05, from about 0.1%, to about 0.5 or to about 3.0% by weight, based on the solids content in the reaction medium. Of course, amounts outside those ranges may be used, as desired.

In embodiments, the coalescence agent may be added at any time between aggregation and coalescence. Coalescence may proceed and be accomplished over a period of from about 0.1 to about 9 hours, from about 0.5 to about 4 hours.

After coalescence, the mixture may be cooled to room temperature, such as, from about 20° C. to about 25° C. The cooling may be rapid or slow, as desired. A suitable cooling method may include introducing cold water in a jacket around the reactor. After cooling, the toner particles optionally may be washed with water and then dried. Drying may be accomplished by any suitable method for drying including, for example, freeze drying.

e. Optional Additives

In embodiments, the toner particles also may contain other optional additives.

i. Charge Additives

The toner may include any known charge additives in amounts of from about 0.1 to about 10 weight %, from about 0.5 to about 7 weight % of the toner. Examples of such charge additives include alkyl pyridinium halides, bisulfates.

Charge enhancing molecules may be used to impart either a positive or a negative charge on a toner particle. Examples include quaternary ammonium compounds, organic sulfate and sulfonate compounds, cetyl pyridinium tetrafluoroborates, distearyl dimethyl ammonium methyl sulfate, aluminum salts and so on.

Such enhancing molecules may be present in an amount of from about 0.1 to about 10%, from about 1 to about 3% by weight.

ii. Surface Modifications

Surface additives may be added to the toner compositions of the present disclosure, for example, after washing or drying. Examples of such surface additives include, for example, one or more of a metal salt, a metal salt of a fatty acid, a colloidal silica, a metal oxide, such as, TiO₂ (for example, for improved RH stability, tribo control and improved development and transfer stability), an aluminum oxide, a cerium oxide, a strontium titanate, SiO₂, mixtures thereof and the like.

Surface additives may be used in an amount of from about 0.1 to about 10 wt %, from about 0.5 to about 7 wt % of the toner.

Other surface additives include lubricants, such as, a metal salt of a fatty acid (e.g., zinc or calcium stearate) or long chain alcohols, such as, UNILIN 700 available from Baker Petrolite and AEROSIL R972® available from Degussa. The coated silicas of U.S. Pat. Nos. 6,190,815 and 6,004,714, the disclosure of each of which hereby is incorporated by reference in entirety, also may be present. The additive may be present in an amount of from about 0.05 to about 5%, from about 0.1 to about 2% of the toner, which additives may be added during the aggregation or blended into the formed toner product.

The gloss of a toner may be influenced by the amount of retained aluminum ion, such as, Al³⁺, in a particle. The amount of retained aluminum ion is controlled by the trisodium citrate dihydrate chelating agent. In embodiments, the amount of retained aluminum ion, in toner particles of the present disclosure may be greater than 150 ppm, or in embodiments greater than about 300 ppm, or greater than about 350 ppm or greater than 400 ppm greater. The gloss level of a toner of the instant disclosure may have a gloss, as measured by Gardner gloss units (gu), of from about 10 gu to less than 60 gu, from about 15 gu to less than 55 gu, from about 15 gu to less than 50 gu.

A particle may contain at the surface one or more silicas, one or more metal oxides, such as, a titanium oxide and a cerium oxide, a lubricant, such as, a zinc stearate and so on. In embodiments, a particle surface may comprise two silicas, two metal oxides, such as, titanium oxide and cerium oxide, and a lubricant, such as, a zinc stearate. All of those surface components may comprise about 5% by weight of a toner particle weight.

Toners may possess suitable charge characteristics when exposed to extreme relative humidity (RH) conditions. The low humidity zone (C zone) may be about 10° C. and 15% RH, while the high humidity zone (A zone) may be about 28° C. and 85% RH.

Toners of the instant disclosure also may possess a parent toner charge per mass ratio (q/m) of from about −5 μC/g to about −90 μC/g, and a final toner charge after surface additive blending of from about −15 μC/g to about −80 μC/g.

Other desirable characteristics of a toner include storage stability, particle size integrity, high rate of fusing to the substrate or receiving member, sufficient release of the image from the photoreceptor, nondocument offset, use of smaller-sized particles and so on, and such characteristics may be obtained by including suitable reagents, suitable additives or both, and/or preparing the toner with particular protocols.

The dry toner particles, exclusive of external surface additives, may have: (1) a volume average diameter (also referred to as “volume average particle diameter”) of from about 2.5 to about 10 μm, from about 2.75 to about 9 μm, from about 4.3 to about 4.9 μm; (2) a number average geometric standard deviation (GSDn) and/or volume average geometric standard deviation (GSDv) of from about 1.18 to about 1.30, from about 1.21 to about 1.24; and (3) circularity of from about 0.9 to about 1.0 (measured with, for example, a Sysmex FPIA 2100 analyzer), from about 0.95 to about 0.985, from about 0.976 to about 0.982. The dry toner particles has aluminum in the amount of at least 100 ppm to 500 ppm based on the weight of the dry toner. In embodiments, the amount of aluminum is from 150 ppm to about 450 ppm, or from about 200 ppm to about 430 ppm.

### Developers

1. Composition

The toner particles thus formed may be formulated into a developer composition. For example, the toner particles may be mixed with carrier particles to achieve a two component developer composition. The toner concentration in the developer may be from about 1% to about 25% by weight of the total weight of the developer, from about 2% to about 15% by weight of the total weight of the developer, with the remainder of the developer composition being the carrier. However, different toner and carrier percentages may be used to achieve a developer composition with desired characteristics.

a. Carrier

Examples of carrier particles for mixing with the toner particles include those particles that are capable of triboelectrically obtaining a charge of polarity opposite to that of the toner particles. Illustrative examples of suitable carrier particles include granular zircon, granular silicon, glass, steel, nickel, ferrites, iron ferrites, silicon dioxide, one or more polymers and the like.

In embodiments, the carrier particles may include a core with a coating thereover, which may be formed from a polymer or a mixture of polymers that are not in close proximity thereto in the triboelectric series, such as, those as taught herein or as known in the art. The coating may include fluoropolymers, such as, polyvinylidene fluorides, terpolymers of styrene, methyl methacrylates, silanes, such as triethoxy silanes, tetrafluoroethylenes, other known coatings and the like.

Various effective suitable means may be used to apply the polymer to the surface of the carrier core, for example, cascade roll mixing, tumbling, milling, shaking, electrostatic powder cloud spraying, fluidized bed mixing, electrostatic disc processing, electrostatic curtain processing, combinations thereof and the like. The mixture of carrier core particles and polymer then may be heated to enable the polymer to melt and to fuse to the carrier core. The coated carrier particles then may be cooled and thereafter classified to a desired particle size.

The carrier particles may be prepared by mixing the carrier core with polymer in an amount from about 0.05 to about 10% by weight, from about 0.01 to about 3% by weight, based on the weight of the coated carrier particle, until adherence thereof to the carrier core is obtained, for example, by mechanical impaction and/or electrostatic attraction.

In embodiments, suitable carriers may include a steel core, for example, of from about 25 to about 100 μm in size, from about 50 to about 75 μm in size, coated with about 0.5% to about 10% by weight, from about 0.7% to about 5% by weight of a polymer mixture including, for example, methylacrylate and carbon black.

### Devices Comprising a Toner Particle

Toners and developers may be combined with a number of devices ranging from enclosures or vessels, such as, a vial, a bottle, a flexible container, such as a bag or a package, and so on, to devices that serve more than a storage function.

1. Imaging Device Components

The toner compositions and developers of interest may be incorporated into devices dedicated, for example, to delivering same for a purpose, such as, forming an image. Hence, particularized toner delivery devices are known, see, for example, U.S. Pat. No. 7,822,370, and may contain a toner preparation or developer of interest. Such devices include cartridges, tanks, reservoirs and the like, and may be replaceable, disposable or reusable. Such a device may comprise a storage portion; a dispensing or delivery portion; and so on; along with various ports or openings to enable toner or developer addition to and removal from the device; an optional portion for monitoring amount of toner or developer in the device; formed or shaped portions to enable siting and seating of the device in, for example, an imaging device; and so on.

2. Toner or Developer Delivery Device

A toner or developer of interest may be included in a device dedicated to delivery thereof, for example, for recharging or refilling toner or developer in an imaging device component, such as, a cartridge, in need of toner or developer, see, for example, U.S. Pat. No. 7,817,944, wherein the imaging device component may be replaceable or reusable.

### Imaging Devices

The toners or developers may be used for electrostatographic or electrophotographic processes, including those disclosed in U.S. Pat. No. 4,295,990, the disclosure of which hereby is incorporated by reference in entirety. In embodiments, any known type of image development system may be used in an image developing device, including, for example, magnetic brush development, jumping single component development, hybrid scavengeless development (HSD) and the like. Those and similar development systems are within the purview of those skilled in the art.

The following Examples illustrate embodiments of the instant disclosure. The Examples are intended to be illustrative only and are not intended to limit the scope of the present disclosure. Parts and percentages are by weight unless otherwise indicated.

### EXAMPLES

### Example 1

A magenta toner was prepared as follows. In a 2 liter glass reactor, the following components were combined: 81.31 g amorphous polyester latex 1 made from an amorphous polyester resin in an emulsion having an Mw of about 19,400, an Mn of about 5,000, a Tg onset of about 60° C., particle size approximately 170-230 nm and about 35% solids of composition terpoly-(propoxylated bisphenol A-terephthalate) terpoly-(propoxylated bisphenol A-dodecenylsuccinate) terpoly-(propoxylated bisphenol A fumarate); 82.94 g amorphous polyester latex 2 made from an amorphous polyester resin in an emulsion, having an average molecular weight (Mw) of about 86,000, a number average molecular weight (Mn) of about 5,600, an onset glass transition temperature (Tg onset) of about 56° C., particle size approximately 70 nm and about 35% solids of composition terpoly-(propoxylated bisphenol A-terephthalate) terpoly-(propoxylated bisphenol A-dodecenylsuccinate) terpoly-(propoxylated bisphenol A fumarate); 7.85 g styrene-acrylate latex 1, prepared using emulsion polymerization at the 300-gallon scale having a Tg (2^{nd} onset) of 59.2 □C, a molecular weight (Mw) of 48 000 g/mol, a particle size of 87 nm and a solids of approximately 39%, 46.26 g; crystalline polyester latex 1, a poly(1,6-hexylene-1,12 dodecanoate) crystalline polyester (with an acid value 6.85 mg KOH/g and viscosity 93.9 centapoise (cP)) was prepared by a solvent-free phase inversion emulsification process made with 2 percent by weight triethanolamine and 5 percent by weight Tayca Power BN2060 to obtain a particle size of about 200 nm and a solids of about 40%, 35.86 g; polymethylene wax in emulsion, having a Tm of about 90° C. and about 30% solids; 26.35 g RE-05 (Quinacridone magenta pigment, available from DIC), 64.11 g Pigment Red 269 (magenta pigment, available from Sun Chemical); and 0.40 g sodium arylsulfonate formaldehyde condensate (Demol SN-B, available from Kao Chemicals) and 464 g deionized water (DIW). Subsequently, the pH was adjusted from 7.83 to 4.77 with 28.60 g of 0.3M nitric acid. Thereafter, about 38.06 g of a flocculent mixture containing about 2.86 g aluminum sulfate and about 35.21 g of DIW was added to the slurry under homogenization at 3000-4000 RPM. Thereafter, the mixture was stirred with at about 370 RPM and heated at a 1° C. per minute temperature increase to a temperature of about 48° C. A shell of 53.97 g amorphous polyester latex 1 an amorphous polyester resin in an emulsion having an Mw of about 19,400, an Mn of about 5,000, a Tg onset of about 60° C., and about 35% solids of composition terpoly-(propoxylated bisphenol A-terephthalate) terpoly-(propoxylated bisphenol A-dodecenylsuccinate) terpoly-(propoxylated bisphenol A fumarate) and 55.04 g amorphous polyester latex 2 an amorphous polyester resin in an emulsion, having an average molecular weight (Mw) of about 86,000, a number average molecular weight (Mn) of about 5,600, an onset glass transition temperature (Tg onset) of about 56° C., and about 35% solids of composition terpoly-(propoxylated bisphenol A-terephthalate) terpoly-(propoxylated bisphenol A-dodecenylsuccinate) terpoly-(propoxylated bisphenol A fumarate) was added to the reactor, and the pH was adjusted from pH 7.37 to 3.80 with 13.55 g 0.3 M nitric acid. This resulting particles had a volume average particle diameter of about 4.3-4.6 μm as measured with a Coulter Counter. The pH of the reactor mixture was adjusted to about 4.8 with a 4% sodium hydroxide solution, followed by the addition of 1.73 g VERSENE 100 [an ethylene diamine tetraacetic acid (EDTA) chelating agent] and 0.84 grams of trisodium citrate dihydrate. The pH of the reactor mixture was then adjusted to about 8.7 with a 4% sodium hydroxide solution, and the stirring reduced to about 180 RPM. The reactor mixture was then heated at a temperature increase of about 1° C. per minute to a temperature of about 84° C. while maintaining the pH at 8.7 using 4% sodium hydroxide solution.

The pH of the mixture was then gradually adjusted to about 7.15 with a sodium acetate buffer solution. The reactor mixture was then gently stirred at about 84° C. for about 2.5 hours to coalesce and spherodize the particles. The mixer was discharged and quenched with deionized ice and maintained a slurry temperature to 40° C. and below while sifting using a 25 μm screen. The toner of this mixture had a volume average particle diameter of about 4.3-4.9 μm, a geometric size distribution (GSD) of about 1.20, and a circularity of about 0.980. The particles were washed 3 times with deionized water at room temperature and then dried using the freeze dryer.

### Example 2

Example 2 was prepared in the manner of Example 1 with the exception that 0.56% by weight TSC is used.

### Example 3

Example 3 was prepared in the manner of Example 1 with the exception that 1.00% by weight TSC is used only. Additionally, Amorphous Polyester Latex 3 was used instead of Amorphous Polyester Latex 2. Amorphous Polyester Latex 3 was prepared from an amorphous polyester resin in an emulsion, having an average molecular weight (Mw) of about 86,000, a number average molecular weight (Mn) of about 5,600, an onset glass transition temperature (Tg onset) of about 56° C., particle size approximately 70 nm and about 35% solids of composition terpoly-(propoxylated bisphenol A-terephthalate) terpoly-(propoxylated bisphenol A-dodecenylsuccinate) terpoly-(propoxylated bisphenol A fumarate).

### Comparative Example 4

In a 2 liter glass reactor, the following components were combined: 80.53 g amorphous polyester latex 1, an amorphous polyester resin in an emulsion having an Mw of about 19,400, an Mn of about 5,000, a Tg onset of about 60° C., and about 35% solids of composition terpoly-(propoxylated bisphenol A-terephthalate) terpoly-(propoxylated bisphenol A-dodecenylsuccinate) terpoly-(propoxylated bisphenol A fumarate); 78.39 g of amorphous polyester latex 3 made from an amorphous polyester resin in an emulsion, having an average molecular weight (Mw) of about 86,000, a number average molecular weight (Mn) of about 5,600, an onset glass transition temperature (Tg onset) of about 56° C., particle size approximately 70 nm and about 35% solids of composition terpoly-(propoxylated bisphenol A-terephthalate) terpoly-(propoxylated bisphenol A-dodecenylsuccinate) terpoly-(propoxylated bisphenol A fumarate); 7.85 g styrene-acrylate latex 1, prepared using emulsion polymerization at the 300-gallon scale having a Tg (2^{nd} onset) of 59.2 □C, a molecular weight (Mw) of 48 000 g/mol, a particle size of 87 nm and a solids of approximately 39%, 46.26 g; crystalline polyester latex 1 a poly(1,6-hexylene-1,12 dodecanoate) crystalline polyester (with an acid value 6.85 mg KOH/g and viscosity 93.9 centapoise (cP)), prepared by a solvent-free phase inversion emulsification process made with 2 percent by weight triethanolamine and 5 percent by weight Tayca Power BN2060 to obtain a particle size of about 200 nm and a solids of about 40%; 36.63 g polymethylene wax in emulsion, having a Tm of about 90° C. and about 30% solids; 26.35 g RE-05 (Quinacridone magenta pigment, available from DIC), 64.11 g Pigment Red 269 (magenta pigment, available from Sun Chemical), 0.40 g sodium arylsulfonate formaldehyde condensate (Demol SN-B, available from Kao Chemicals) and 627 g deionized water. Subsequently, the pH was adjusted from 8.14 to 4.70 with 31.32 g of 0.3M nitric acid. Thereafter, about 38.06 g of a flocculent mixture containing about 2.86 g aluminum sulfate and about 35.21 g of deionized water was added to the slurry under homogenization at 3000-4200 RPM. Thereafter, the mixture was stirred at about 360 RPM and heated at a 1° C. per minute temperature increase to a temperature of about 47° C. A shell of 53.44 g amorphous polyester latex 1 made from an amorphous polyester resin in an emulsion having an Mw of about 19,400, an Mn of about 5,000, a Tg onset of about 60° C., particle size approximately 170-230 nm and about 35% solids of composition terpoly-(propoxylated bisphenol A-terephthalate) terpoly-(propoxylated bisphenol A-dodecenylsuccinate) terpoly-(propoxylated bisphenol A fumarate, and 52.03 g amorphous polyester latex 3 made from an amorphous polyester resin in an emulsion, having an average molecular weight (Mw) of about 86,000, a number average molecular weight (Mn) of about 5,600, an onset glass transition temperature (Tg onset) of about 56° C., particle size approximately 70 nm and about 35% solids of composition terpoly-(propoxylated bisphenol A-terephthalate) terpoly-(propoxylated bisphenol A-dodecenylsuccinate) terpoly-(propoxylated bisphenol A fumarate) was added to the reactor, after pH adjusted from pH 7.68 to 3.85 with 14.73 g 0.3 M nitric acid. This resulted in particles having a volume average particle diameter of about 4.5-4.7 μm as measured with a Coulter Counter. The pH of the reactor mixture was adjusted to about 4.8 with a 4% sodium hydroxide solution, followed by the addition of about 2.15 grams of VERSENE 100 [an ethylene diamine tetraacetic acid (EDTA) chelating agent]. The pH of the reactor mixture was then adjusted to about 8.7 with a 4% sodium hydroxide solution, and the stirring reduced to about 185 RPM. The reactor mixture was then heated at a temperature increase of about 1° C. per minute to a temperature of about 84° C. while maintaining the pH at 8.7 using 4% sodium hydroxide solution. The pH of the mixture was then gradually adjusted to about 7.30 with a sodium acetate buffer solution. The reactor mixture was then gently stirred at about 84° C. for about 2 hours to coalesce and spherodize the particles. The mixer is then discharged and quenched with deionized ice and maintained a slurry temperature to 40° C. and below while sifting using a 25 μm screen. The toner of this mixture had a volume average particle diameter of about 4.3-4.9 μm, a geometric size distribution (GSD) of about 1.20, and a circularity of about 0.980. The particles were washed 3 times with DIW at room temperature and then dried using the freeze dryer.

Table 1 shows particle properties for Examples 1-3 and Comparative Example 4 with the respective agents. Examples 2 shows the highest amount of Al at 482 ppm with 0.56 pph TSC, while Example 3 shows the lowest amount of Al at 280 ppm with 1 pph TSC. Example 1 with a combination of EDTA and TSC for at a total of 1.01 pph of chelator, has a slightly higher amount of Al than Example 3 (with the 1 pph TSC) at 340 ppm. For reference, Comparative Example 4 has 465 ppm in residual Al with 0.56 EDTA. These results show that TSC alone, or in combination with EDTA, provides a lower gloss toner, or other lower gloss products. Also, since TSC is less expensive, it can be used at higher amounts.

TABLE 1

| | | | | Comparative |
|---|---|---|---|---|
| | Ex. 1 | Ex. 2 | Ex. 3 | Ex. 4 |
| Slurry pH before | 4.8 | 4.8 | 4.8 | 4.8 |
| aggregant | | | | |
| Shell latex pH | 3.8 | 3.8 | 3.8 | 3.8 |
| Freeze Temperature | 51.5° C. | 51.6° C. | 50.2° C. | 48.2° C. |
| EDTA Versene ™ | 0.45 | 0 | 0 | 0.56 |
| (pph) | | | | |
| TSC (pph) | 0.56 | 0.56 | 1.00 | 0 |
| Final Freeze pH | 8.7 | 8.7 | 8.7 | 8.7 |
| Coalescence | 84° C. | 84° C. | 84° C. | 84° C. |
| Temperature | | | | |
| Final Coalescence pH | 7.20 | 7.15 | 7.15 | 7.30 |
| Spherodization time | 150 | 165 | 150 | 121 |
| (minutes) | | | | |
| Wet D₅₀ᵥ | 4.88 | 4.73 | 5.04 | 4.99 |
| GSDv | 1.22 | 1.22 | 1.22 | 1.21 |
| GSDn | 1.27 | 1.34 | 1.30 | 1.27 |
| Circularity | 0.977 | 0.979 | 0.978 | 0.978 |
| Residual Aluminum | 340.2 | 481.8 | 280.3 | 464.8 |
| (ppm) | | | | |

Bench charge was obtained for parent toner by weighing the toner at 6% TC with 30 grams standard carrier at 30 gram scale. For the blended toner EA toner a 10 L Henschel blend was done with a known additive package comprising silicas, surface treated titanium and polytetrafluoroethylene in certain amounts. After conditioning samples a minimum of 48 hours for J-zone (at about 21.1° C. and 10% RH), and a minimum 24 hours for A-zone (at about 28° C./85% relative humidity), the developers were charged in a Turbula mixer 10 minutes for parent developer and 10′ and 60 minutes for the blended toner with additives. The toner charge was measured in the form of q/d, the charge to diameter ratio. The q/d was measured using a charge spectrograph visually as the midpoint of the toner charge distribution. The charge was reported in millimeters of displacement from the zero line. The final mm displacement can be converted to femtocoulombs/micron (fC/μm) by multiplying by 0.092.

The toner charge per mass ratio (Q/M) was also determined by the total blow-off charge method, measuring the charge on a faraday cage containing the developer after removing the toner by blow-off in a stream of air. The total charge collected in the cage is divided by the mass of toner removed by the blow-off, by weighing the cage before and after blow-off to give the Q/M ratio. Good charging performance was observed for all toners compared to the Comparative Example. The parent charge was equal or lower than the Comparative Example.

Bench charging evaluation is summarized in Table 2.

TABLE 2

| | Parent Charge | | | | Additive Charge | | | | | |
|---|---|---|---|---|---|---|---|---|---|---|
| | 10′ Tubula | | | | 60′ Tubula | | | | | |
| | q/d (mm) | | q/m (uC/g) | | q/d (mm) | | q/m (uC/g) | | Cohesion | Blocking |
| Example | AZ | JZ | AZ | JZ | AZ | JZ | AZ | JZ | (%) | Onset (° C.) |
| Comparative | 3.0 | 19.2 | 19.0 | 129.6 | 5.7 | 9.1 | 39.8 | 83.8 | 7.2 | 54.1 |
| Example 4 | | | | | | | | | | |
| Example 1 | 2.8 | 13.0 | 15.1 | 112.4 | 5.6 | 9.2 | 40.5 | 74.0 | 7.9 | 54.1 |
| Example 2 | 2.1 | 16.2 | 17.9 | 109.9 | 5.4 | 6.3 | 40.2 | 65.3 | 5.5 | 54.2 |
| Example 3 | 2.1 | 16.0 | 14.2 | 103.8 | 5.6 | 9.2 | 42.4 | 74.5 | 7.6 | 54.1 |

The samples submitted for fusing evaluation were blended with additives (silica and titania) to improve flow and charging using the SKM mill from Kyoritsu (about 12,000 rpm for 30 seconds).

Toner was then placed into a modified Xerox® Color 560 printer to generate unfused images. These were a simple square target placed in the center of the page with a TMA (toner mass per unit area) of 0.62 mg/cm2 of toner on Xerox® Bold 90 gsm, uncoated paper (P/N 3R11540) and used for gloss, crease, and hot offset measurements. In general, two to four passes through the Xerox® Color 560 printer are required while adjusting the bias and/or the copier lightness setting to achieve the desired TMA.

Samples were fused with an oil-less fusing fixture, consisting of a Xerox 700 production fuser CRU that was fitted with an external motor and temperature control along with paper transports. The process speed of the fuser was set to 308.7 mm/s (nip dwell of −27 ms) and the fuser roll temperature was varied from cold offset to hot offset or up to 220° C. for gloss and crease measurements on the samples. After the set point temperature of the fuser roll has been changed, there is a wait time of ten minutes to allow the temperature of the belt and pressure assembly to stabilize.

Cold offset is the temperature at which toner sticks to the fuser, but is not yet fusing to the paper. Above the cold offset temperature, the toner does not offset to the fuser until it reaches the Hot offset temperature.

Crease Area.

The toner image displays mechanical properties such as crease, as determined by creasing a section of the substrate such as paper with a toned image thereon and quantifying the degree to which the toner in the crease separates from the paper. A good crease resistance may be considered a value of less than 1 mm, where the average width of the creased image is measured by printing an image on paper, followed by (a) folding inwards the printed area of the image, (b) passing over the folded image a standard Teflon™ coated copper roll weighing about 860 grams, (c) unfolding the paper and wiping the loose ink from the creased imaged surface with a cotton swab, and (d) measuring the average width of the ink free creased area with an image analyzer. The crease value can also be reported in terms of area, especially when the image is sufficiently hard to break unevenly on creasing; measured in terms of area, crease values of 100 millimeters correspond to about 1 mm in width. Further, the images exhibit fracture coefficients, for example of greater than unity.

From the image analysis of the creased area, it is possible to determine whether the image shows a small single crack line or is more brittle and easily cracked. A single crack line in the creased area provides a fracture coefficient of unity while a highly cracked crease exhibits a fracture coefficient of greater than unity. The greater the cracking, the greater the fracture coefficient.

Minimum Fixing Temperature.

The Minimum Fixing Temperature (MFT) measurement involves folding an image on paper fused at a specific temperature, and rolling a standard weight across the fold. The print can also be folded using a commercially available folder such as the Duplo D-590 paper folder. The folded image is then unfolded and analyzed under the microscope and assessed a numerical grade based on the amount of crease showing in the fold. This procedure is repeated at various temperatures until the minimum fusing temperature (showing very little crease) is obtained.

Gloss.

Print gloss (Gardner gloss units or “gu”) was measured using a 75 degree BYK Gardner gloss meter for toner images that had been fused at a fuser roll temperature range of about 120° C. to about 210° C. Sample gloss was dependent on the toner, the toner mass per unit area, the paper substrate, the fuser roll, and fuser roll temperature.

Gloss Mottle.

The gloss mottle temperature is the temperature at which the print shows a mottled texture, characterized by non-uniform gloss on the mm scale on the print, and is due to the toner beginning to stick to the fuser in small areas.

Hot Offset.

The hot offset temperature (HOT) is that temperature that toner that has contaminated the fuser roll is seen to transfer back onto paper. To observe it a blank piece of paper, a chase sheet, is sent through the fuser right after the print with the fused image. If an image offset is notice on the blank chase sheet at a certain fuser temperature then this is the hot offset temperature.

Trisodium citrate dihydrate (TSC) was used in Examples 1-3. TSC extracts less aluminum from the toner particles than other chelators resulting in lower gloss.

Aluminum levels correlate with print gloss. A higher residual aluminum will result in lower print gloss; that is, a lower peak gloss and a gloss curve shifted to higher fuser roll temperatures. Both Example 2 and Example 3 had a wide fusing latitude (>103° C.) and no variation in print gloss (mottle) or toner hot offset to the fuser roll. Example 2, which was made with 0.56 ppm TSC, had an MFT of 118° C. In comparison, Example 3 which was made with a higher amount of TSC (1.00 pph), had a lower MFT (113° C. versus 118° C.). As expected, Example 3 was glossier than Example 2 (peak gloss was 49 gu versus 34 gu, respectively) since it was made with more TSC and resulted in less residual aluminum. Table 3 summarizes the results. Using trisodium citrate dihydrate or a combination of trisodium citrate dihydrate and EDTA one can obtain higher residual Al and thus lower gloss. This is seen by comparing Example 2 and Comparative Example 4, which were both made with 0.56% chelating agent. However, by using TSC instead of EDTA, Example 2 resulted in higher residual aluminum and therefore lower peak gloss than Comparative Example 4 (34 gu versus 42 gu).

TABLE 3

| | | | | Comparative |
|---|---|---|---|---|
| | Example 1 | Example 2 | Example 3 | Example 4 |
| Chelator | 0.45% EDTA + | 0.56% TSC | 1.00% TSC | 0.56% EDTA |
| | 0.56% TSC | | | |
| Residual Al (ppm) | 340.2 | 481.8 | 280.3 | 464.8 |
| Gloss @ MFT | 22.1 | 16.7 | 20.3 | 16.1 |
| Gloss @ 185° C. | 45.2 | 31.7 | 48.5 | 37.7 |
| Peak Gloss | 46.0 | 34.0 | 49.0 | 42.0 |
| HOT @ 220 mm/s | >221 | >221 | >221 | >221 |
| Gloss Mottle @ 220 mm/s | >221 | >221 | >221 | >221 |
| Cold Offset | 124 | 121 | 121 | 121 |
| Fix Latitude (CA = 80/COT) | >97/>97 | >103/>103 | >108/>108 | >100/>100 |
| T(G₃₀) | 138 | 176 | 133 | 159 |
| T(G₄₀) | 164 | / | 156 | 196 |
| MFT_{(CA = 80)} | 116 | 118 | 113 | 118 |

*Cold offset temperature, Fix Latitude = (HOT on CXS paper − MFT) or (Maximum Fuser
Roll Temperature − MFT). Temperature to achieve acceptable fix

It will be appreciated that variants of the above-disclosed and other features and functions or alternatives thereof, may be combined into other different systems or applications. Various presently unforeseen or unanticipated alternatives, modifications, variations, or improvements therein may be subsequently made by those skilled in the art which are also encompassed by the following claims.

1. A method for manufacturing a low gloss toner, the method comprising:
mixing a resin, a colorant comprising pigment particles selected from the group consisting of; cyan, yellow, magenta, black, orange, red, green, an optional wax, in water to form an emulsion;
heating the emulsion in the presence of an aluminum coagulent selected from the group consisting of: polyaluminum chloride, polyaluminum bromide, polyaluminum fluoride, polyaluminum iodide, polyaluminum silicate, aluminum sulfate, aluminum chloride, aluminum nitrate, and potassium aluminum sulfate to form a plurality of aggregated particles of resin, colorant, charge control agent and optional wax, wherein the heating is to a temperature of below the glass transition temperature of the resin;
adding trisodium citrate dihydrate to the heated emulsion in an amount of from 0.4 weight percent to about 1.0 percent by weight based on a total weight of reagents while stirring;
heating the aggregated particles to a temperature above the glass transition temperature of the resin to form toner particles have a volume average particle diameter of from 4.3 microns to 4.9 microns;
separating the toner particles from the water; and
drying the toner particles wherein the toner particles comprise a gloss unit of from 15 to 50 and wherein the toner particles comprise amount of aluminum coagulant of from about 0.1 pph to about 3 pph by weight of toner particles.

2. (canceled)

3-6. (canceled)

7. The method according to claim 1, wherein the resin is selected from the group consisting of: poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and combinations thereof.

8. The method according to claim 1, further comprising:
forming a shell on the aggregated particles.

9. The method according to claim 1, wherein the optional wax is selected from the group consisting of: polyolefins, plant-based waxes, petroleum-based waxes, ester waxes, sorbitan higher fatty acid ester waxes and cholesterol higher fatty acid ester waxes.

10. The method according to claim 1, wherein the toner particles further comprise a surfactant.

11. The method according to claim 1, wherein the toner particles further comprise a surface additive.

12. A method for manufacturing a low gloss toner, the method comprising:
mixing a resin, a colorant comprising pigment particles selected from the group consisting of: cyan, yellow, magenta, black, orange, red, green, an optional wax, in water to form an emulsion;
heating the emulsion in the presence of an aluminum coagulant selected from the group consisting of: polyaluminum chloride, polyaluminum bromide, polyaluminum fluoride, polyaluminum iodide, polyaluminum silicate, aluminum sulfate, aluminum chloride, aluminum nitrate, and potassium aluminum sulfate to form a plurality of aggregated particles of resin, colorant, charge control agent and optional wax, wherein the heating is to a temperature below the glass transition temperature of the resin;
adding trisodium citrate dihydrate to the heated emulsion while stirring, wherein the trisodium citrate dihydrate is added in amount of from 0.4 weight percent to about 1.0 percent by weight based on of a total weight of reagents;
heating the aggregated particles to a temperature above the glass transition temperature of the resin to form toner particles having a volume average particle diameter of from 4.3 microns to 4.9 microns;
separating the toner particles from the water; and
drying the toner particles wherein the toner particles comprise a gloss unit of from 15 to 50 and wherein the toner particles comprise amount of aluminum coagulant of from about 0.1 pph to about 3 pph by weight of toner particles.

13. (canceled)

14. (canceled)

15. The method according to claim 12, wherein the toner particles have an aluminum concentration of from 150 ppm to about 500 ppm based on the weight of the particles.

16. (canceled)

17. The method according to claim 12, wherein the resin is selected from the group consisting of: poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and combinations thereof.

18. (canceled)

19. A low gloss toner comprising:
particles comprising a resin, a colorant comprising pigment particles selected from the group consisting of: cyan, yellow, magenta, black, orange, red, green, a wax, wherein the particles have a size of from 4.3 microns to about 4.9 microns, wherein the particles comprise an aluminum concentration of greater than 150 ppm and a gloss unit of from 15 to 50.

20. The low gloss toner according to claim 19 wherein the particles have a shell.
